(19) United States
(12) Patent Application Publication
(10) Pub. No.: US 2023/0297243 A1
(43) Pub. Date: Sep. 21, 2023

(54) METHOD AND APPARATUS FOR PREDICTING SERVICE LIFE OF SOLID-STATE DISK, AND COMPUTER-READABLE STORAGE MEDIUM

(71) Applicant: INSPUR SUZHOU INTELLIGENT TECHNOLOGY CO., LTD., Suzhou, Jiangsu (CN)

(72) Inventor: Qi CAO, Suzhou, Jiangsu (CN)

(21) Appl. No.: 18/020,607

(22) PCT Filed: May 27, 2021
(86) PCT No.: PCT/CN2021/096291

§ 371 Date: Feb. 9, 2023

(30) Foreign Application Priority Data
Aug. 20, 2020 (CN) 202010843689.X

(51) Int. Cl. G06F 3/06; G06F 30/27

(52) U.S. Cl. CPC G06F 3/0616; G06F 3/0653; G06F 3/0679; G06F 30/27; G06F 2111/10

(57) ABSTRACT

A method and apparatus for predicting the service life of a solid-state disk (SSD), and a computer-readable storage medium. The method includes: acquiring user system writes per day of a to-be-test solid-state disk within a preset historical period, and generating a difference historical time sequence representing daily changes of the user system writes of the to-be-test solid-state disk within the preset historical period; inputting the difference historical time sequence into a pre-trained exponential smoothing model, and obtaining a daily change predicting value of the user system writes of the to-be-test solid-state disk within a preset future period; and predicting the service life of the to-be-test solid-state disk according to an actual user system writes during a day previous to a prediction day, the change predicting value and a total bytes written (TBW) of the to-be-test solid-state disk.

### CROSS-REFERENCE TO RELATED APPLICATION

The present application claims priority to the Chinese patent application No. 202010843689.X filed on Aug. 20, 2020 to the CNIPA, China National Intellectual Property Administration, and entitled “METHOD AND APPARATUS FOR PREDICTING SERVICE LIFE OF SOLID-STATE DISK, AND COMPUTER-READABLE STORAGE MEDIUM”, which is incorporated herein in its entirety by reference.

### TECHNICAL FIELD

The present application relates to the technical field of service life detection of solid-state disks, and particularly relates to a method and apparatus for predicting a service life of a solid-state disk and a computer-readable storage medium.

### BACKGROUND

Solid-state disks (SSD) are hard disks that are fabricated by solid state electronic storage chip arrays, and include a control unit and a storage unit such as a coded flash memory (FLASH) chip or a dynamic random access memory (DRAM) chip. Due to the advantages of fast reading and writing, a light weight, a low energy consumption and a small size, SSDs replace traditional hard disk drives (HDD), and are widely applied in various fields such as military, vehicle-mounted devices, industrial control, video monitoring, network monitoring, network terminals, electric power, medical treatment, aviation and navigation devices.

As a high-performance alternative solution for HDD, the flash-based SSDs have been widely sought after since their inception. Furthermore, with the improvement of the flash memory technique and the drop of the price, SSDs have a broader market and a brighter prospect. However, at the same time, the reliability of the SSDs is reduced due to the increase in the density of flash. The performance and the error rate of the SSDs are directly related to the service life of the SSDs. The closer to the end of the service life, the worse the performance of the SSDs and the higher the error rate. In order to ensure the safety and the accuracy of the data, the SSDs are required to be replaced before the end of the service life. In other words, the SSDs have a life limit, and the prediction on the SSD life is of vital importance for the performance of the SSDs.

It can be understood that the service life of an SSD may be represented by a wear degree or total bytes written (TBW). Particularly, the number of the program/erase cycle (P/E Cycle) of an SSD is a fixed value. The data writing causes the increasing of the number of the erasing and writing of the SSD, i.e., causing SSD wearing. When the volume of data written by the user is sufficiently high or the SSD has been 100% worn out, it is considered that the SSD is no longer reliable, and the life has reached the end. In accordance with the Joint Electron Device Engineering Council (JEDEC) standard, when the SSD is delivered, SSD manufacturers will set a rated TBW for the SSD, which represents the total data volume that the user can write into the SSD in typical scenes.

In the related art, all of the SSD manufacturers such as Intel and HPE (Hewlett Packard Enterprise) use a fixed life calculating formula to predict the SSD life. The fixed life calculating formula may be expressed as:

$$Remaining life = \frac{Δduration}{Δuser bytes written} \times ( TBW - user writes ) .$$

As can be seen from the fixed life calculating formula, when the SSD life is predicted in the related art, all of the historical data are utilized equally, in other words, the previous daily changes are equally treated. However, in the actual SSD usage process, future user writes will most likely be similar to the recent writes. Therefore, the SSD life cannot be accurately predicted if all of the historical data are equally utilized.

In view of the above, how to increase a prediction accuracy of the SSD life is a technical problem to be solved by those skilled in the art.

### SUMMARY

The present application provides a method and apparatus for predicting a service life of a solid-state disk and a computer-readable storage medium.

In order to solve the above technical problem, embodiments of the present disclosure provide technical solutions described below.

An aspect of the embodiments of the present disclosure provides a method for predicting a service life of a solid-state disk, including:
acquiring user system writes per day of a to-be-test solid-state disk within a preset historical period, and generating a difference historical time sequence representing daily changes of the user system writes of the to-be-test solid-state disk within the preset historical period;
inputting the difference historical time sequence into a pre-trained exponential smoothing model, and obtaining a daily change predicting value of the user system writes of the to-be-test solid-state disk within a preset future period; and
predicting the service life of the to-be-test solid-state disk according to an actual user system writes during a day previous to the prediction day, the change predicting value and a total bytes written (TBW) of the to-be-test solid-state disk.

In some embodiments, the generating a difference historical time sequence representing daily changes of the user system writes of the to-be-test solid-state disk within the preset historical period includes:
determining, within the preset historical period, whether the to-be-test solid-state disk has user system writes information in every single day;
in response to determining the to-be-test solid-state disk has user system writes information in every single day, calculating difference values of a user system writes sequence at intervals of one day of the to-be-test solid-state disk, and generating a first order difference historical time sequence; and
in response to determining the to-be-test solid-state disk does not have user system writes information in every single day, filling null terms of the user system writes by interpolation, calculating, based on a user system writes sequence that has been filled, difference values at intervals of one day, and generating the first order difference historical time sequence.

In some embodiments, the acquiring user system writes per day of a to-be-test solid-state disk within a preset historical period includes:
in the preset historical period, calling a smartct-a command in a smartctl tool to obtain detailed self-monitoring analysis and reporting technology (S.M.A.R.T.) parameter information of the to-be-test solid-state disk from a S.M.A.R.T. software at a fixed time of every day; and
acquiring parameter value of smart ID 241 index from the detailed S.M.A.R.T. parameter information, and using the parameter value of smart ID 241 index as user system writes of the to-be-test solid-state disk in a current day.

In some embodiments, before inputting the difference historical time sequence into a pre-trained exponential smoothing model, the method further includes:
inputting the difference historical time sequence into an exponential smoothing model, performing model training, and obtaining smoothing coefficient values of the exponential smoothing model by fitting through maximum likelihood estimation.

In some embodiments, the predicting the service life of the to-be-test solid-state disk according to an actual user system writes during a day previous to the prediction day, the change predicting value and a total bytes written (TBW) of the to-be-test solid-state disk includes:
acquiring a true value of the user system writes during the day previous to the prediction day, that is used as the actual user system writes;
continuously accumulating the change predicting value based on the actual user system writes, and obtaining a predicting value of the user system writes per day within the preset future period; and
calculating, according to the predicting value of the user system writes per day within the preset future period and the total bytes written of the to-be-test solid-state disk, a number of remaining days of the life of the to-be-test solid-state disk.

In some embodiments, the exponential smoothing model is y′ₜ₊₁=ayₜ+(1−a)y′ₜ, where y′ₜ₊₁ is a predicting value of the user system writes of the to-be-test solid-state disk during a (t+1)-th day, a is the smoothing coefficient, yₜ is an actual user system writes of the to-be-test solid-state disk during a t-th day, and y′ₜ is a predicting value of the user system writes of the to-be-test solid-state disk during the t-th day.

Another aspect of the embodiments of the present disclosure provides an apparatus for predicting a service life of a solid-state disk, including:
an information acquiring module, configured to acquire user system writes per day of a to-be-test solid-state disk within a preset historical period, generate a difference historical time sequence representing daily changes of the user system writes of the to-be-test solid-state disk within the preset historical period;
a daily change predicting module, configured to input the difference historical time sequence into a pre-trained exponential smoothing model, and obtain daily change predicting value of the user system writes of the to-be-test solid-state disk within a preset future period; and
a service life predicting module, configured to predict the service life of the to-be-test solid-state disk according to an actual user system writes during a day previous to a prediction day, the change predicting value and a total bytes written (TBW) of the to-be-test solid-state disk.

In some embodiments, the apparatus further includes a model coefficient calculating module that is configured to input the difference historical time sequence into an exponential smoothing model to perform model training, and obtain a smoothing coefficient value of the exponential smoothing model by fitting through maximum likelihood estimation.

Embodiments of the present disclosure further provide an apparatus for predicting a service life of a solid-state disk. The apparatus includes a processor configured to execute a computer program stored in a memory to implement the steps of the method for predicting a service life of a solid-state disk stated above.

Embodiments of the present disclosure further provide a computer-readable storage medium. The computer-readable storage medium is stored with a program for predicting a service life of a solid-state disk that, when executed by a processor, implements the steps of the method for predicting a service life of a solid-state disk stated above.

It should be understood that the above general description and the following detailed description are merely exemplary, and cannot limit the present disclosure.

### BRIEF DESCRIPTION OF THE DRAWINGS

In order to more clearly illustrate the technical solutions of the embodiments of the present disclosure or the related art, the figures that are required to describe the embodiments or the related art will be briefly described below. Apparently, the figures that are described below are merely embodiments of the present disclosure, and those skilled in the art can obtain other figures according to these figures without paying creative work.

FIG. 1 is a schematic flow chart of a method for predicting a service life of a solid-state disk according to an embodiment of the present disclosure;

FIG. 2 is a schematic flow chart of another method for predicting a service life of a solid-state disk according to an embodiment of the present disclosure;

FIG. 3 is a structural diagram illustrating a particular implementation of an apparatus for predicting a service life of a solid-state disk according to an embodiment of the present disclosure; and

FIG. 4 is a structural diagram illustrating another particular implementation of an apparatus for predicting a service life of a solid-state disk according to an embodiment of the present disclosure.

### DETAILED DESCRIPTION

In order to enable those skilled in the art to better comprehend the solutions of the present disclosure, the present disclosure will be further described in detail below with reference to the drawings and the particular embodiments. Apparently, the described embodiments are merely certain embodiments of the present disclosure, rather than all of the embodiments. All of the other embodiments that those skilled in the art obtains on the basis of the embodiments of the present disclosure without paying creative work fall within the protection scope of the present disclosure.

The terms such as “first”, “second”, “third” and “fourth” in the description, the claims and the drawings of the present application are intended to distinguish different objects, and are not intended to describe a particular sequence. Moreover, the terms “comprise” and “have” and any variation thereof are intended to cover non-exclusive inclusions. For example, a process, method, system, product or device that comprises a series of steps or units is not limited to those steps or units that have been listed, but may comprise steps or units that are not listed.

After the technical solutions of the embodiments of the present disclosure have been introduced, the non-limiting implementations of the present application will be described in detail below.

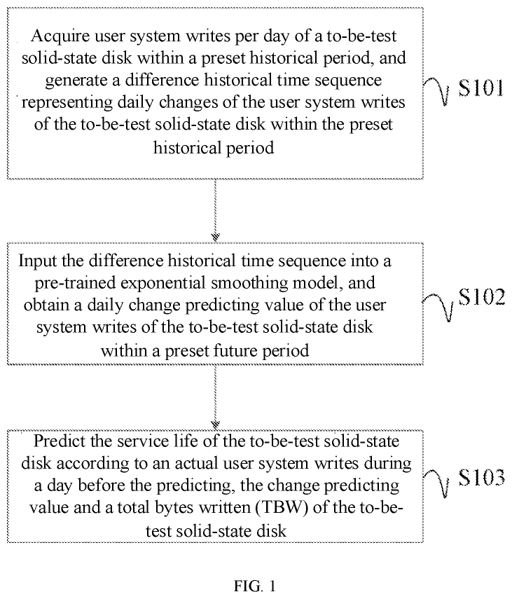

Firstly, referring to FIG. 1 that is a schematic flow chart of a method for predicting a service life of a solid-state disk according to an embodiment of the present disclosure, the embodiment of the present disclosure may include steps described below.

At S101, user system writes per day of a to-be-test solid-state disk within a preset historical period are acquired, to generate a difference historical time sequence representing daily changes of the user system writes of the to-be-test solid-state disk within the preset historical period.

In the present embodiment, the preset historical period is a certain period in the past of the to-be-test solid-state disk, and those skilled in the art may determine a starting point of the preset historical period according to practical application scenes, which is not limited in the present application. What is acquired in S101 is the user system writes per day of the to-be-test solid-state disk within the preset historical period. It can be understood that, if the user system writes during a day within the preset historical period cannot be acquired for a certain reason, in other words, the user system writes during that day is a null term, then the user system writes may be replaced by a result of subtracting an empirical value from the user system writes during the next day, and the null term may also be filled by interpolation, which is not limited in the present application. After the user system writes per day of the to-be-test solid-state disk within the preset historical period have been acquired, a time sequence is formed based on time stamps and values of the user system writes. The time sequence contains true values of the user system writes of the to-be-test solid-state disk during every single day within the preset historical period. After the time sequence has been obtained, changes of the user system writes of the to-be-test solid-state disk during every single day within the preset historical period may be calculated based on the time sequence. For example, a difference historical time sequence may be obtained by calculating the first order difference values at intervals of one day. Certainly, the difference historical time sequence may also be obtained by using other mathematical methods, which does not influence the implementation of the present application.

At S102, the difference historical time sequence is input into a pre-trained exponential smoothing model, to obtain daily change predicting value of the user system writes of the to-be-test solid-state disk within a preset future period.

The exponential smoothing model according to the present application may employ any one of the exponential smoothing models in the related art. An exponential smoothing model refers to a time sequence analyzing and predicting model based on an exponential smoothing method, and predicts the future of a phenomenon by calculating an exponential smoothing value in cooperation with a certain time sequence predicting model. The principle is that the exponential smoothing value of any stage is a weighted average of the actual observed value of the current stage and the exponential smoothing value of the previous stage. In other words, the exponential smoothing model can enhance the influence of recent write change values on the predicting values. The weights assigned to write change values at different times are different, where the recent write change values have a higher weight, and early write change values have a lower weight, so that the predicting values can quickly reflect changes in recent writes. Furthermore, the exponential smoothing method has a scalability with respect to the assigned weights, and different smoothing coefficients may be taken to change the changing rate of the weights. If the smoothing coefficient is small, then the weight changes quickly, and the predicting values can quickly reflect the recent changes of the writes per day. The smoothing coefficient may be manually specified. In other words, those skilled in the art may determine the smoothing coefficient empirically based on actual application scenes, and may also obtain the smoothing coefficient by fitting the historical data, which does not influence the implementation of the present application.

It can be understood that the user system writes of the solid-state disk are essentially the total user writes, and is an accumulated value of the writes, which is a progressively increasing number and is not suitable to be used as the input of the exponential smoothing model. In view of that, in the present application, the difference historical time sequence obtained based on the user system writes is used as the input of the model. In this way, a future change of the difference values of the user system writes of the to-be-test solid-state disk can be obtained by predicting, so as to obtain the predicting values of the daily changes of the user system writes within a future period.

At S103, a service life of the to-be-test solid-state disk is predicted according to an actual user system writes during a day previous to a prediction day, the daily change predicting value and a total bytes written of the to-be-test solid-state disk.

In this step, the actual user system writes during the day previous to the prediction day is the true user system writes of the to-be-test solid-state disk, and the day previous to the prediction day is the day before a starting point of the preset future period, and the starting point of the preset future period is the prediction day. The total bytes written refer to a total volume of data that is allowed to be written into the to-be-test solid-state disk, and the total bytes written are prescribed when the to-be-test solid-state disk is delivered. The daily change predicting value may be continuously accumulated on the basis of the actual user system writes during the day previous to the prediction day, to restore the user system writes, and the time when the user system writes reach the manufacturer-rated total bytes written is the end of the life of the to-be-test solid-state disk. The life prediction realizes a time-quantized expression of the reliability of the SSD, so that the user knows the remaining usage of the SSD intuitively. Each SSD disk is separately modeled, and the SSD remaining life as seen by a user is actually a customized calculation result for that user. The user may decide when to replace the SSD or perform data backup based on the remaining life of the SSD and the value of the data in the SSD, thereby ensuring the safety of the data. As SSDs are expensive, the SSD life prediction can facilitate the user to minimize redundant configurations and reduce the procurement cost, and can prevent economic loss caused by insufficient spare parts and sudden SSD failures, thereby realizing benefit maximization.

In the technical solutions according to the embodiments of the present disclosure, based on the daily historical difference data of the user writes of the solid-state disk, the exponential smoothing model is called to predict and obtain the changes of the user writes of the solid-state disk in the future period, and predicted difference changes are finally accumulated to restore the user writes. The time when the restored user writes reach the manufacturer-rated TBW is the end of the life. By using the exponential smoothing model, the influence of recent writes changes on the predicting values is further enhanced. Weights assigned to writes change values at different times are different, where the recent writes change values have a higher weight, and write change values of early phase have a lower weight, so that the predicting values can quickly reflect the changes in the recent writes. Therefore, the problem of a low prediction accuracy of the SSD life in the related art caused by treating previous daily changes equally, which does not meet the actual situation in which the user future writes is similar to that of a recent phase with a high probability, is solved. The prediction accuracy of the SSD life is effectively increased, which enables the user to know the remaining life of the SSD more intuitively and accurately, and guarantees the safety of the user data. Furthermore, the exponential smoothing model has a scalability with respect to the assigned weights, different smoothing coefficients may be taken to change the changing rate of the weights, and the predicting values can quickly reflect the recent changes of daily writes, to adapt for various user usage situations with a high universality.

The above embodiments do not limit the exponential smoothing model adopted, and the present embodiment provides an implementation of the exponential smoothing model. The exponential smoothing model may be expressed as y′ₜ₊₁=ayₜ+(1−a)y′ₜ, where y′ₜ₊₁ is a predicting value of the user system writes of the to-be-test solid-state disk during a (t+1)-th day, a is a smoothing coefficient, yₜ is an actual user system writes of the to-be-test solid-state disk during a t-th day, and y′ₜ is a predicting value of the user system writes of the to-be-test solid-state disk during the t-th day.

The true user system writes within the preset historical period and the daily changes of the user system writes within the preset historical period that are acquired in S101 may be used as sample data to train the exponential smoothing model, the smoothing coefficient value a of the exponential smoothing model is obtained by fitting through maximum likelihood estimation, and then the smoothing-coefficient value a obtained through calculation is substituted into the exponential smoothing model, thereby obtain a trained exponential smoothing model.

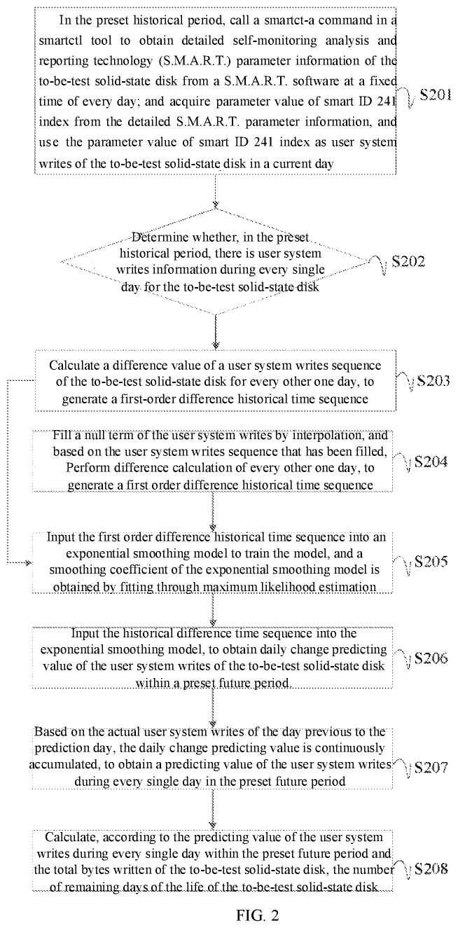

Finally, the present application further provides another method for predicting a service life of a solid-state disk. Referring to FIG. 2, the method may include steps described below.

At S201, in a preset historical period, a smartct-a command in a smartctl tool is called to, at a fixed time of every day, obtain detailed self-monitoring analysis and reporting technology (S.M.A.R.T.) parameter information of the to-be-test solid-state disk from a S.M.A.R.T. software, and acquire a smart ID 241 index parameter value from the detailed S.M.A.R.T. parameter information, and the smart ID 241 index parameter value is used as a user system writes of the to-be-test solid-state disk during the current day.

Smartctl is a command-line kit or tool for performing a self-monitoring analysis and reporting Technology (SMART) task in a Unix-type system. The S.M.A.R.T. (Self-Monitoring Analysis and Reporting Technology) software is a self-monitoring analysis and reporting technology software that is built in the solid-state disk. The smart ID 241 index parameter of the software is the user system writes, and the user system writes per day of the to-be-test solid-state disk within the preset historical period may be acquired from the software. Furthermore, the technical solutions according to the present application may be applied in an existing storage managing software, for example, S.M.A.R.T., which can increase the degree of intellectualization of the storage managing software.

At S202, it is determined whether, in the preset historical period, the to-be-test solid-state disk has user system writes information in every single day, and if yes, then S203 is executed, otherwise, S204 is executed.

At S203, difference values of a user system writes sequence at intervals of one day of the to-be-test solid-state disk are calculated, to generate a first order difference historical time sequence.

At S204, a null term of the user system writes is filled by interpolation, and based on the user system writes sequence that has been filled, difference values at intervals of one day are calculated, to generate a first order difference historical time sequence.

Each of the user system writes per day has a time stamp. The time stamps of every single day within the preset historical period are used as a time-stamp sequence and expanded to be continuous dates, and the terms whose user system writes is empty are filled by interpolation.

At S205, the first order difference historical time sequence is input into an exponential smoothing model to train the model, and a smoothing coefficient of the exponential smoothing model is obtained by fitting through maximum likelihood estimation.

At S206, the historical difference time sequence is input into the exponential smoothing model, to obtain daily change predicting value of the user system writes of the to-be-test solid-state disk within a preset future period.

The future changes of the difference values of the user system writes may be predicted by using the exponential smoothing model, to obtain the predicting values of the daily changes of the host-writes within a future period.

At S207, based on the actual user system writes of the day previous to the prediction day, the daily change predicting value is continuously accumulated, to obtain a predicting value of the user system writes during every single day within the preset future period.

At S208, according to the predicting value of the user system writes during every single day within the preset future period and the total bytes written of the to-be-test solid-state disk, the number of remaining days of the life of the to-be-test solid-state disk is calculated.

In this step, the true value of the user system writes during the day previous to the prediction day may be acquired from the detailed S.M.A.R.T. parameter information, and used as the actual user system writes during the day previous to the prediction day. On the basis of the actual user system writes during the day previous to the prediction day, the daily change predicting value is continuously accumulated, to obtain a predicting value of the user system writes during every single day in the preset future period. According to the predicting value of the user system writes during every single day in the preset future period and the total bytes written of the to-be-test solid-state disk, the number of remaining days of the life of the to-be-test solid-state disk is calculated.

As stated above, in the embodiments of the present disclosure, the recent change of the user system writes has a higher weight, and the early change has a lower weight, which is more like the actual scenes, whereby the predicted life of the solid-state disk is more accurate. The model parameters are automatically optimized, and no artificial intervention is required, which further increases the accuracy and the intellectualization degree of the model prediction.

It should be noted that the steps according to the present application do not have a strict execution order, and as long as a logical order is satisfied, then those steps may be executed simultaneously, and may also be executed in a certain preset order. FIGS. 1 and 2 are merely an illustrative mode, and do not limit the execution order.

The embodiments of the present disclosure further provide an apparatus corresponding to the method for predicting a service life of a solid-state disk, which further enables the method to have more practical applicability. The apparatus may be described from the perspective of the functional modules and the perspective of the hardware. The apparatus for predicting a service life of a solid-state disk according to an embodiment of the present disclosure will be described below. The apparatus for predicting a service life of a solid-state disk described below and the method for predicting a service life of a solid-state disk described above may correspondingly refer to each other.

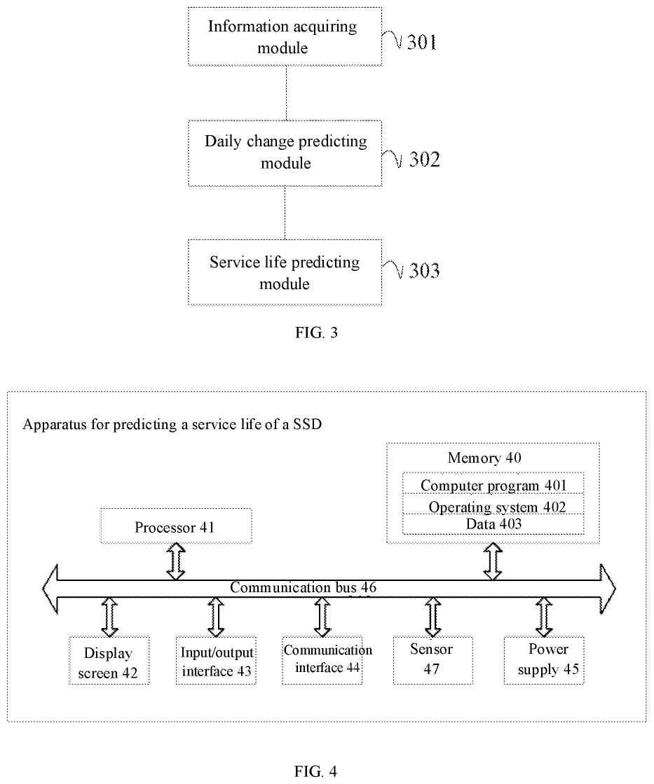

In the perspective of functional modules, referring to FIG. 3 that is a structural diagram illustrating a particular implementation of an apparatus for predicting a service life of a solid-state disk according to an embodiment of the present disclosure. The apparatus may include an information acquiring module 301, a daily change predicting module 302 and a service life predicting module 303.

The information acquiring module 301 is configured to acquire user system writes per day of a to-be-test solid-state disk within a preset historical period, generate a difference historical time sequence representing daily changes of the user system writes of the to-be-test solid-state disk within the preset historical period.

The daily change predicting module 302 is configured to input the difference historical time sequence into a pre-trained exponential smoothing model, and obtain daily change predicting value of the user system writes of the to-be-test solid-state disk within a preset future period.

The service life predicting module 303 is configured to predict the service life of the to-be-test solid-state disk according to an actual user system writes during a day previous to a prediction day, the daily change predicting value and a total bytes written (TBW) of the to-be-test solid-state disk.

In some embodiments, in some embodiments of the present embodiment, the apparatus may further include, for example, a model coefficient calculating module. The model coefficient calculating module is configured to input the difference historical time sequence into an exponential smoothing model to perform model training, and obtain a smoothing coefficient value of the exponential smoothing model by fitting through maximum likelihood estimation.

In some other implementations of the embodiments of the present disclosure, the service life predicting module 303 may include:
an actual data acquiring submodule, configured to acquire a true value of the user system writes during the day previous to the prediction day, that is used as the actual user system writes;
a change predicting submodule, configured to, based on the actual user system writes, continuously accumulate the daily change predicting value, to obtain a predicting value of the user system writes during every single day in the preset future period; and
a life predicting submodule, configured to calculate, according to the predicting value of the user system writes during every single day in the preset future period and the total bytes written of the to-be-test solid-state disk, the number of remaining days of the life of the to-be-test solid-state disk.

In some embodiments, in some other implementations of the present embodiment, the information acquiring module 301 may further include:
a judging submodule, configured to determine, within the preset historical period, whether the to-be-test solid-state disk has user system writes information in every single day;
a first order difference time sequence generating module, configured to, if the to-be-test solid-state disk has user system writes information during every single day, calculate difference values of a user system writes sequence at intervals of one day of the to-be-test solid-state disk, and generate a first order difference historical time sequence; and
a data-null-term filling submodule, configured to fill a null term of the user system writes by interpolation, and based on the user system writes sequence that has been filled, calculate difference values at intervals of one day, and generate a first order difference historical time sequence.

In some other implementations of the present embodiment, the information acquiring module 301 may further comprise, for example:
a S.M.A.R.T. parameter acquiring submodule, configured to call a smartct-a command in a smartctl tool to obtain, at a fixed time of every day, detailed self-monitoring analysis and reporting technology (S.M.A.R.T.) parameter information of the to-be-test solid-state disk from a S.M.A.R.T. software; and
a user system writes acquiring submodule, configured to acquire a smart ID 241 index parameter value from the detailed S.M.A.R.T. parameter information, and the smart ID 241 index parameter value is used as a user system writes of the to-be-test solid-state disk during the current day.

The functions of the functional modules of the apparatus for predicting a service life of a solid-state disk according to an embodiment of the present disclosure may be particularly implemented by using the methods in the above process embodiments, and the particular implementing processes may refer to the relevant description on the above process embodiments, and are not discussed herein further.

It can be known that the embodiments of the present disclosure effectively increase the prediction accuracy of the SSD life, so that the user knows the remaining usage of the SSD more intuitively and accurately, and the safety of the user data is guaranteed.

The apparatus for predicting a service life of a solid-state disk described above is described in the perspective of the functional modules. Further, the present application further provides an apparatus for predicting a service life of a solid-state disk, which is described in the perspective of the hardware. FIG. 4 is a structural diagram illustrating another apparatus for predicting a service life of a solid-state disk according to an embodiment of the present application. As shown in FIG. 4, the apparatus includes a memory 40 configured to storing a computer program; and a processor 41 configured to execute the computer program to implement the steps of the method for predicting a service life of a solid-state disk according to any one of the above embodiments.

The processor 41 may include one or more processing cores, for example, a 4-core processor and an 8-core processor. The processor 41 may be implemented in at least one of the hardware forms of Digital Signal Processing (DSP), Field-Programmable Gate Array (FPGA) and Programmable Logic Array (PLA). The processor 41 may also include a host processor and a co-processor. The host processor refers to a processor that processes the data in the awaken state, and is also referred to as a central processing unit (CPU). The co-processor refers to a low-power-consumption processor that processes the data in the standby state. In some embodiments, the processor 41 may be integrated with a Graphics Processing Unit (GPU), where the GPU is configured to render and draw the contents that the display screen is required to display. In some embodiments, the processor 41 may further include an artificial intelligence (AI) processor that is configured to process calculating operations related to machine learning.

The memory 40 may include one or more computer-readable storage mediums that may be non-transient. The memory 40 may further include a high-speed random access memory and a non-volatile memory, for example, one or more magnetic-disk storage devices and flash-memory storage devices. In the present embodiment, the memory 40 is at least configured to store the following computer program 401, where the computer program, after loaded and executed by the processor 41, can implement the relevant steps of the method for predicting a life of a solid-state disk according to any one of the above embodiments. Additionally, the resources stored by the memory 40 may further include an operating system 402, data 403 and so on, and the storage mode may be short-term storage or permanent storage. The operating system 402 may include Windows, Unix, Linux and so on. The data 403 may include but are not limited to the data corresponding to the test result.

In some embodiments, the apparatus for predicting a service life of a solid-state disk may further include a display screen 42, an input/output interface 43, a communication interface 44, a power supply 45 and a communication bus 46.

Those skilled in the art can understand that the structure shown in FIG. 4 does not limit the apparatus for predicting a service life of a solid-state disk, and the apparatus may include components more or fewer than those illustrated, for example, a sensor 47.

The functions of the functional modules of the apparatus for predicting a service life of a solid-state disk according to an embodiment of the present disclosure may be particularly implemented by using the methods in the above process embodiments, and the particular implementing processes may refer to the relevant description on the above process embodiments, and are not discussed herein further.

It can be known that the embodiments of the present disclosure effectively increase the prediction accuracy of the SSD life, so that the user knows the remaining usage of the SSD more intuitively and accurately, and the safety of the user data is guaranteed.

It can be understood that the method for predicting a service life of a solid-state disk according to the above embodiments, if implemented in the form of software function units and sold or used as an independent product, may be stored in a computer-readable storage medium. On the basis of such a comprehension, the substance of the technical solutions of the present application, or the part thereof that makes a contribution over the related art, or the whole or part of the technical solutions, may be embodied in the form of a software product. The computer software product is stored in a storage medium, and implements all or some of the steps of the methods according to the embodiments of the present application. Moreover, the above-described storage medium includes various media that can store a program code, such as a USB flash disk, a mobile hard disk drive, a Read-Only Memory (ROM), a Random Access Memory (RAM), an Electrically Erasable Programmable ROM, a register, a hard disk, a movable magnetic disk, a CD-ROM, a diskette and an optical disk.

Based on that, an embodiment of the present disclosure further provides a computer-readable storage medium. The computer-readable storage medium stores a program for predicting a life of a solid-state disk, and the program for predicting a life of a solid-state disk, when executed by a processor, implements the steps of the method for predicting a life of a solid-state disk according to any one of the above embodiments.

The functions of the functional modules of the computer-readable storage medium according to an embodiment of the present disclosure may be particularly implemented by using the methods in the above process embodiments, and the particular implementing processes may refer to the relevant description on the above process embodiments, and are not discussed herein further.

It can be known that the embodiments of the present disclosure effectively increase the accuracy of the prediction on the SSD life, so that the user knows the remaining usage of the SSD more intuitively and accurately, and the safety of the user data is guaranteed.

The embodiments of the description are described in the mode of progression, each of the embodiments emphatically describes the differences from the other embodiments, and the same or similar parts of the embodiments may refer to each other. Regarding the devices disclosed by the embodiments, because they correspond to the methods disclosed by the embodiments, they are described simply, and the relevant parts may refer to the description on the methods.

Those skilled in the art can further understand that the units and the algorithm steps of the examples described with reference to the embodiments disclosed herein may be implemented by using electronic hardware, a computer software or a combination thereof. In order to clearly explain the interchangeability between the hardware and the software, the above description has described generally the configurations and the steps of the examples according to the functions. Whether those functions are executed by hardware or software depends on the particular applications and the design constraints of the technical solutions. Those skilled in the art may employ different methods to implement the described functions with respect to each of the particular applications, but the implementations should not be considered as extending beyond the scope of the present disclosure.

The method and apparatus for predicting a service life of a solid-state disk and the computer-readable storage medium according to the present application have been described in detail above. The principle and the embodiments of the present disclosure are described herein with reference to the particular examples, and the description of the above embodiments is merely intended to facilitate to understand the method according to the present disclosure and its core concept. It should be noted that those skilled in the art may make improvements and modifications on the present application without departing from the principle of the present disclosure, and all of the improvements and modifications fall within the protection scope of the claims of the present application.

1. A method for predicting a service life of a solid-state disk, comprising:
acquiring user system writes per day of a to-be-test solid-state disk within a preset historical period, and generating a difference historical time sequence representing daily changes of the user system writes of the to-be-test solid-state disk within the preset historical period;
inputting the difference historical time sequence into a pre-trained exponential smoothing model, and obtaining a daily change predicting value of the user system writes of the to-be-test solid-state disk within a preset future period; and
predicting the service life of the to-be-test solid-state disk according to an actual user system writes during a day previous to a prediction day, the change predicting value and a total bytes written (TBW) of the to-be-test solid-state disk.

2. The method for predicting a service life of a solid-state disk according to claim 1, wherein the generating a difference historical time sequence representing daily changes of the user system writes of the to-be-test solid-state disk within the preset historical period comprises:
determining, within the preset historical period, whether the to-be-test solid-state disk has user system writes information in every single day;
in response to determining the to-be-test solid-state disk has user system writes information in every single day, calculating difference values of a user system writes sequence at intervals of one day of the to-be-test solid-state disk, and generating a first order difference historical time sequence; and
in response to determining the to-be-test solid-state disk does not have user system writes information in every single day, filling null terms of the user system writes by interpolation, calculating, based on a user system writes sequence that has been filled, difference values at intervals of one day, and generating the first order difference historical time sequence.

3. The method for predicting a service life of a solid-state disk according to claim 2, wherein the acquiring user system writes per day of a to-be-test solid-state disk within a preset historical period comprises:
in the preset historical period, calling a smartct-a command in a smartctl tool to obtain detailed self-monitoring analysis and reporting technology (S.M.A.R.T.) parameter information of the to-be-test solid-state disk from a S.M.A.R.T. software at a fixed time of every day; and
acquiring parameter value of smart ID 241 index from the detailed S.M.A.R.T. parameter information, and using the parameter value of smart ID 241 index as user system writes of the to-be-test solid-state disk in a current day.

4. The method for predicting a service life of a solid-state disk according to claim 1, wherein before inputting the difference historical time sequence into a pre-trained exponential smoothing model, the method further comprises:
inputting the difference historical time sequence into an exponential smoothing model, performing model training, and obtaining smoothing coefficient values of the exponential smoothing model by fitting through maximum likelihood estimation.

5. The method for predicting a service life of a solid-state disk according to claim 1, wherein the predicting the service life of the to-be-test solid-state disk according to an actual user system writes during a day previous to a prediction day, the change predicting value and a total bytes written (TBW) of the to-be-test solid-state disk comprises:
acquiring a true value of the user system writes during the day previous to the prediction day, that is used as the actual user system writes;
continuously accumulating the change predicting value based on the actual user system writes, and obtaining a predicting value of the user system writes during every single day within the preset future period; and
calculating, according to the predicting value of the user system writes during every single day within the preset future period and the total bytes written of the to-be-test solid-state disk, a number of remaining days of the life of the to-be-test solid-state disk.

6. The method for predicting a service life of a solid-state disk according to claim 5, wherein the exponential smoothing model is y′ₜ₊₁=ayₜ+(1−a)y′ₜ,
wherein y′ₜ₊₁ is a predicting value of the user system writes of the to-be-test solid-state disk during a (t+1)-th day, a is a smoothing coefficient, yₜ is an actual user system writes of the to-be-test solid-state disk during a t-th day, and y′ₜ is a predicting value of the user system writes of the to-be-test solid-state disk during the t-th day.

7. (canceled)

8. (canceled)

9. An apparatus for predicting a service life of a solid-state disk, comprising:
a memory configured to store a computer program; and
a processor configured to execute the computer program to:
acquire user system writes per day of a to-be-test solid-state disk within a preset historical period, and generate a difference historical time sequence representing daily changes of the user system writes of the to-be-test solid-state disk within the preset historical period;
input the difference historical time sequence into a pre-trained exponential smoothing model, and obtain a daily change predicting value of the user system writes of the to-be-test solid-state disk within a preset future period; and
predict the service life of the to-be-test solid-state disk according to an actual user system writes during a day previous to a prediction day, the change predicting value and a total bytes written (TBW) of the to-be-test solid-state disk.

10. A non-transient computer-readable storage medium, wherein the computer-readable storage medium is stored with a program for predicting a service life of a solid-state disk that, when executed by a processor, causes the processor to:
acquire user system writes per day of a to-be-test solid-state disk within a preset historical period, and generate a difference historical time sequence representing daily changes of the user system writes of the to-be-test solid-state disk within the preset historical period;
input the difference historical time sequence into a pre-trained exponential smoothing model, and obtain a daily change predicting value of the user system writes of the to-be-test solid-state disk within a preset future period; and
predict the service life of the to-be-test solid-state disk according to an actual user system writes during a day previous to a prediction day, the change predicting value and a total bytes written (TBW) of the to-be-test solid-state disk.

11. The method for predicting a service life of a solid-state disk according to claim 1, wherein the exponential smoothing model is a time sequence analyzing and predicting model based on an exponential smoothing method.

12. The method for predicting a service life of a solid-state disk according to claim 11, wherein the exponential smoothing method has a scalability with respect to assigned weights, and different smoothing coefficients are taken to change changing rate of the weights, wherein recent changes of the user system writes have a higher weight, and early changes of the user system writes have a lower weight.

13. The method for predicting a service life of a solid-state disk according to claim 1, wherein the prediction day is a starting point of the preset future period.

14. The method for predicting a service life of a solid-state disk according to claim 1, wherein the total bytes written refer to a total volume of data that is allowed to be written into the to-be-test solid-state disk,

15. The method for predicting a service life of a solid-state disk according to claim 6, wherein the smoothing coefficient is preset, or is determined by fitting historical data.

16. The apparatus for predicting a service life of a solid-state disk according to claim 9, wherein the processor is further configured to:
determine, within the preset historical period, whether the to-be-test solid-state disk has user system writes information in every single day;
in response to determining the to-be-test solid-state disk has user system writes information in every single day, calculate difference values of a user system writes sequence at intervals of one day of the to-be-test solid-state disk, and generate a first order difference historical time sequence; and
in response to determining the to-be-test solid-state disk does not have user system writes information in every single day, fill null terms of the user system writes by interpolation, calculate, based on a user system writes sequence that has been filled, difference values at intervals of one day, and generate the first order difference historical time sequence.

17. The apparatus for predicting a service life of a solid-state disk according to claim 16, wherein the processor is further configured to:
in the preset historical period, call a smartct-a command in a smartctl tool to obtain detailed self-monitoring analysis and reporting technology (S.M.A.R.T.) parameter information of the to-be-test solid-state disk from a S.M.A.R.T. software at a fixed time of every day; and
acquire parameter value of smart ID 241 index from the detailed S.M.A.R.T. parameter information, and use the parameter value of smart ID 241 index as user system writes of the to-be-test solid-state disk in a current day.

18. The apparatus for predicting a service life of a solid-state disk according to claim 9, wherein the processor is further configured to:
input the difference historical time sequence into an exponential smoothing model, performing model training, and obtain smoothing coefficient values of the exponential smoothing model by fitting through maximum likelihood estimation.

19. The apparatus for predicting a service life of a solid-state disk according to claim 9, wherein the processor is further configured to:
acquire a true value of the user system writes during the day previous to the prediction day, that is used as the actual user system writes;
continuously accumulate the change predicting value based on the actual user system writes, and obtain a predicting value of the user system writes during every single day within the preset future period; and
calculate, according to the predicting value of the user system writes during every single day within the preset future period and the total bytes written of the to-be-test solid-state disk, a number of remaining days of the life of the to-be-test solid-state disk.

20. The apparatus for predicting a service life of a solid-state disk according to claim 19, wherein the exponential smoothing model is y′ₜ₊₁=ayₜ+(1−a)y′ₜ,
wherein y′ₜ₊₁ is a predicting value of the user system writes of the to-be-test solid-state disk during a (t+1)-th day, a is a smoothing coefficient, yₜ is an actual user system writes of the to-be-test solid-state disk during a t-th day, and y′ₜ is a predicting value of the user system writes of the to-be-test solid-state disk during the t-th day.

21. The apparatus for predicting a service life of a solid-state disk according to claim 9,
wherein the prediction day is a starting point of the preset future period.

22. The apparatus for predicting a service life of a solid-state disk according to claim 9, wherein the total bytes written refer to a total volume of data that is allowed to be written into the to-be-test solid-state disk.
